(19) United States
(12) Patent Application Publication
(10) Pub. No.: US 2015/0179015 A1
(43) Pub. Date: Jun. 25, 2015

(54) VENDING MACHINE ADVERTISING SYSTEM

(71) Applicant: MCLAREN LLC, Monterey Park, CA (US)

(72) Inventor: Stephanie Chang, Monterey Park, CA (US)

(21) Appl. No.: 14/566,328

(22) Filed: Dec. 10, 2014

Related U.S. Application Data
(60) Provisional application No. 61/919,422, filed on Dec. 20, 2013.

(51) Int. Cl. G07F 9/02; G06Q 30/02

(52) U.S. Cl. CPC G07F 9/023; G06Q 30/0269

(57) ABSTRACT

A system for displaying advertising to consumers includes: a display panel; a product dispenser configured to dispense a plurality of products; a computer system including a processor, memory, and a storage device, the computer system being configured to: display a plurality of advertisements on the display panel, the advertisements being stored on the storage device; receive a selection of a selected product from among the plurality of products; and control the product dispenser to dispense the selected product, wherein at least one of the plurality of advertisements is unrelated to the plurality of products.

### CROSS-REFERENCE TO RELATED APPLICATION

This application claims the benefit of and priority to U.S. Provisional Patent Application Ser. No. 61/919,422, titled “Vending Machine Advertising System,” filed in the United States Patent and Trademark Office on Dec. 20, 2013, the entire disclosure of which is incorporated herein by reference.

### BACKGROUND

Generally, consumers are drawn to vending machines primarily on an as needed basis. Consumers are mostly need driven, that is, consumers are generally drawn to vending machines that sell snacks when the consumers are hungry, and they are drawn to soda or other beverage machine when they are thirsty. Vending machines traditionally distinguish themselves from one another based on how they were “dressed up” on the outside, with the hope that consumers will be able to spot the machines from a distance.

On the financial side, traditional merchants generally rely primarily on the sales of products sold by the vending machine to determine profitability of a particular machine.

### SUMMARY

Embodiments of the present invention are directed to systems and methods for dispensing both a “paid for product” (e.g., a beverage), while also delivering messages from various advertisers, so that interactive information can be exchanged between a consumer (or a user) and the machine (or a vending system). Embodiments of the present invention are also directed to offering interactive recommendations to help consumers select products to purchase from the vending machine.

According to one embodiment, a system for displaying advertising to consumers includes: a display panel; a product dispenser configured to dispense a plurality of products; a computer system including a processor, memory, and a storage device, the computer system being configured to: display a plurality of advertisements on the display panel, the advertisements being stored on the storage device; receive a selection of a selected product from among the plurality of products; and control the product dispenser to dispense the selected product, wherein at least one of the plurality of advertisements is unrelated to the plurality of products.

The system may further include a camera, and the computer system may be further configured to: receive image data from the camera, the image data including an image of a person; analyze the image data to detect a status of the person; identify a recommended product from the plurality of products in accordance with the detected status; and display the recommended product on the display.

The status of the person may include a mood of the person.

The system may further include a camera, and the computer system may be further configured to: receive image data from the camera; analyze the image data to detect a status; and display an advertisement from the plurality of advertisements in accordance with the detected status.

The status may include a mood of a person depicted in the image data.

The computer system may be further configured to: detect whether activity is low based on image data; show an advertisement when the detected activity is not low; and stop showing advertisements and sleep when the detected activity is low.

The system may further include a network adapter and the computer system may be configured to receive the plurality of advertisements via the network adapter and to store the received plurality of advertisements on the storage device.

### BRIEF DESCRIPTION OF THE DRAWINGS

FIG. 1 is a schematic diagram on an exterior of a vending machine with an advertising system according to one embodiment of the present invention.

FIG. 2 is a system block diagram of a vending machine with an advertising system according to one embodiment of the present invention.

FIG. 3 is a flowchart illustrating a method for scheduling advertisements and vending products according to one embodiment of the present invention.

FIG. 4 is a flowchart illustrating a method for identifying and displaying recommended products in accordance with detected external information according to one embodiment of the present invention.

FIG. 5 is a flowchart illustrating a method for identifying and displaying an advertisement in accordance with detected external information according to one embodiment of the present invention.

FIG. 6 is a flowchart illustrating a method for detecting activity and displaying an advertisement based on whether or not a low level of activity is detected according to one embodiment of the present invention.

### DETAILED DESCRIPTION

Embodiments of the present invention are directed to systems and methods for displaying advertising on a vending machine, where the advertising is directed to goods and services that may be different from the goods dispensed by the vending machine or supplied from a different source than the source of the goods dispensed by the machine.

Generally, embodiments of the present invention are also directed to systems and methods that allow consumers to select their products via a direct selection (e.g., pressing a button), based on their aura signals (as detected by an aura sensor), or based on their mood signals (as detected by a mood sensor), where the detected aura signals or mood signals are matched against various criteria (e.g., pre-set criteria).

These machines can be placed in public places such as airports, fitness centers, amusements parks, golf courses, car washes, dealerships, universities, hospitals, churches, libraries, military bases, etc. One example of a usage scenario is: a customer impatiently waiting at the airport for his flight and now sees a vending machine displaying advertising and interacting with other customers and have him see the machine and walk up to buy a drink.

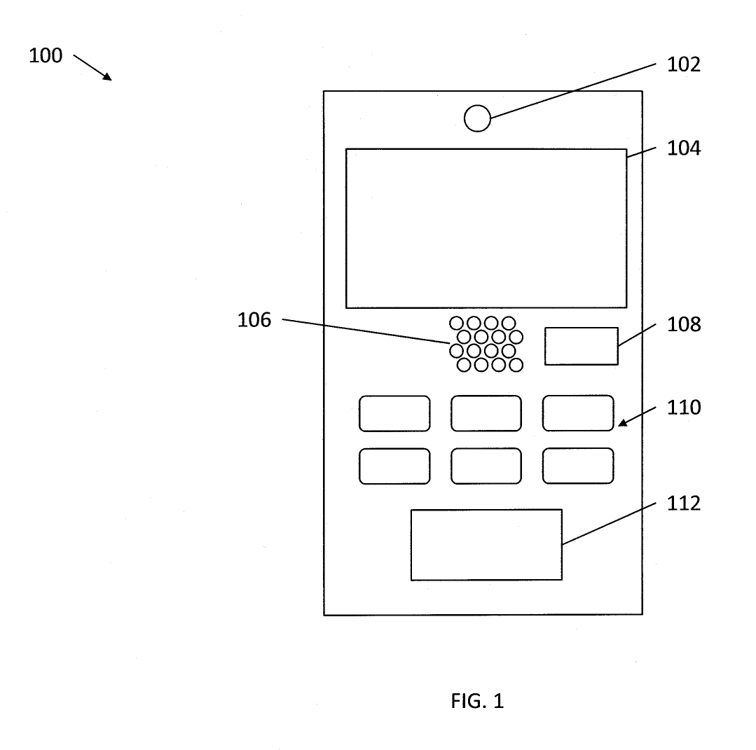

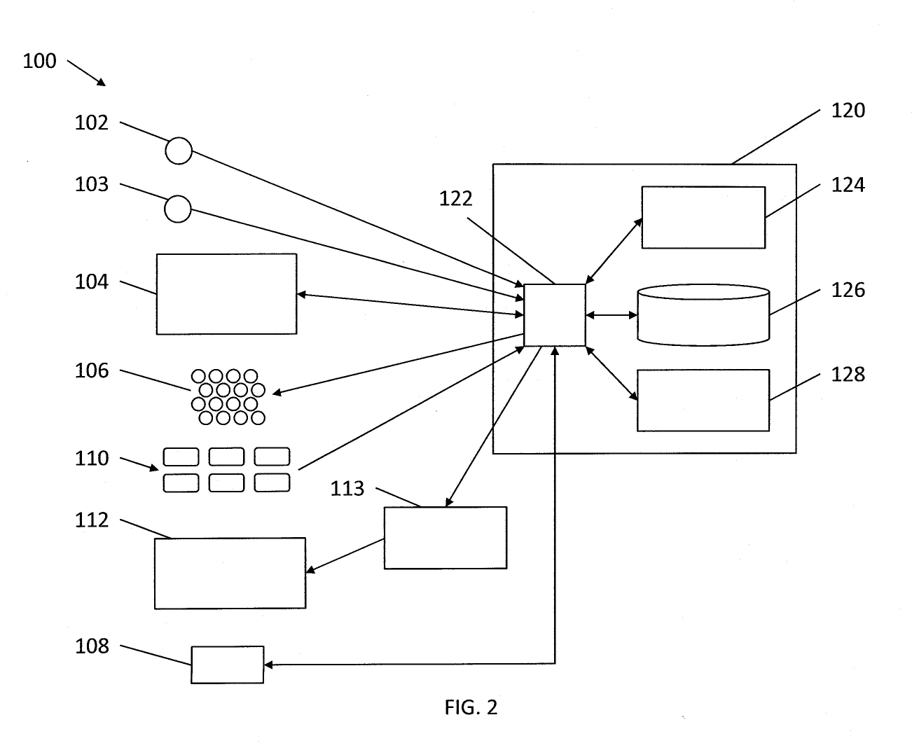

FIG. 1 is a schematic diagram on an exterior of a vending machine with an advertising system according to one embodiment of the present invention and FIG. 2 is a system block diagram of a vending machine with an advertising system according to one embodiment of the present invention. The various components labeled in FIGS. 1 and 2 will be described in more detail below.

Referring to FIG. 1, a user-facing side of a machine (or vending machine) 100 according to one embodiment of the present invention includes a camera 102, a display 104, a speaker 106, a payment collection module 108, control buttons 110, and a product dispenser 112. In some embodiment of the present invention, the control buttons 110 are omitted and a user may interface with the machine 100 using other controls. For example, the display 104 may include a touch sensitive panel (or “touch panel”).

According to one embodiment of the present invention, the payment collection module 104 is a module capable of reading a credit card or a near field communication (NFC) smart card, and/or capable of accepting coins and bills and determining the amount of money inserted.

According to one embodiment, the control buttons 110 may be conventional push buttons that allow a customer to select from a variety of products (e.g., drinks). The processor may be receive a customer's selection through the buttons to control the product dispenser to dispense the selected product.

According to one embodiment, the product dispenser 112 is a mechanism configured to dispense the products selected and paid for by the consumer. These products may include, for example, cold drinks such as canned and bottled sodas, energy drinks, flavored and unflavored water, hot drinks such as coffee, tea, and hot chocolate, etc. These may include systems for mechanically selecting and releasing a product from a shelf or stack within the machine, releasing a cup and dispensing a liquid into the cup, or any of a variety of other systems known in the art for automatically dispensing a product.

According to one embodiment, the LCD/LED display panel 104 as a message delivery medium between our machine and the consumer (user). Non-related merchants, advertisers, vendors are able to choose the form of message to be displayed on the LCD/LED screen. Motion commercials/advertising clips of any merchants/advertisers may be edited to have a standard length (e.g., 30 seconds), and they have the option to have the message played by in a programmable frequencies throughout the day. In other embodiments, the advertisements are shown as static images that may include accompanying audio.

In addition, the display panel 104 may be used to display information during a transaction with a consumer. For example, the display panel 104 may display information such as details about the products available for purchase through the machine, instructions on how to operate the machine, and the amount of money deposited by the user.

The speaker 106 may be a component of the display or may be a separate device and may be used to play audio such as audio feedback for the user's interactions with the machine 100 (e.g., depositing coins, pressing buttons, and/or interacting with the touch screen) and may be used to play back audio associated with advertisements (e.g., the advertisements shown on the display).

Referring to FIG. 2, according to one embodiment of the present invention, the machine 100 includes an onboard computer 120 with a central processing unit (CPU) 122 coupled to a non-transitory storage device 126 (e.g., a hard drive or flash memory storage device). The computer 120 may also include a network interface 124 and a memory 128. The onboard computer 120 stores the still images, video, and/or audio advertisements to be shown on the display 104 and/or played through the speaker 106. The computer 120 is configured to control which message to play and when and how frequently the messages are played. The advertisements and the scheduling or timing of advertisements can be controlled by parameters set through the network interface 124.

In some embodiments, the advertisements are not stored on the storage device 126 and instead are streamed to the computer 120 over the network interface 124. In embodiments of the present invention using a network streaming of advertisements, the advertisements may be temporarily stored in the storage device and/or the memory 128.

The program includes multiple instructions stored in the memory 128 and the storage device 126 of the computer system and executed by the CPU to perform the various operations. In some embodiments of the present invention, the computer 120 is integrated with the display 104, such as the case if a tablet computer or a laptop computer is used in the machine 100.

The network adapter 124 enables the computer 120 to receive updated information including new advertisements and parameters associated with the display of those advertisements. The network adapter 124 can also be used to report sales information and to track machine status, such as generating alerts when products/supplies (such as cups or drink) need to be replenished or when the cash collection bin is approaching full. In some embodiments, the network adapter 124 operates via a wired wide area network (WAN) connection (e.g., an Ethernet connection), a connection to a wireless network (e.g., WiFi), a cellular network (such as 4G LTE, HPSA, etc.), or other equivalent connections to a private network and/or the Internet.

Customized advertising programs are transmitted to the machine 100 through the network adapter 124, and stored on the storage device 126, and then processed to be displayed on the display 104 during operation.

In one embodiment, the frequency with which the advertisements are played or shown is centrally controlled by a remote control center which controls the display of advertisements on multiple similarly equipped vending machines across a geographic area. Utilizing the interne and the cellular or wireless networking technology, customized programs are sent to the machines controlling which advertisements are shown and when they are shown. The scheduling of advertisements can be controlled at varying levels of granularity, such that advertisements targeting particular demographic and/or geographic markets are only displayed on particular machines meeting those demographic and/or geographic constraints.

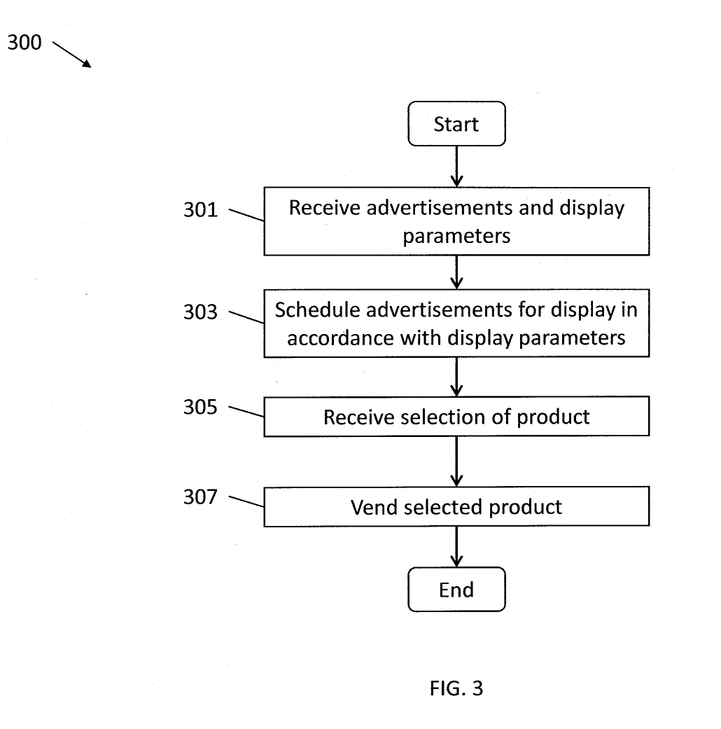

Referring to FIG. 3, the computer 120 is configured to automatically schedule the showing of advertising on the display 104 based on the parameters received from the network interface. For example, a particular car commercial on a new model could have a 30 second run time and could be played at least once every 6 minutes during a particular 8 hour period of time. The computer 120 schedules playback of the car commercial during particular slots of time while also meeting the scheduling requirements of other advertisements to be displayed by the machine 100. For example, the advertisements can be sorted from least frequent to most frequent. Each advertisement is then taken in turn and inserted in to the schedule at the maximum allowable intervals (e.g., exactly once every six minutes). If there is already an advertisement scheduled for that time slot, then the advertisement is scheduled for the earliest open time slot prior to the attempted slot. The process is repeated for all of the advertisements to be shown. If there are additional open slots, then the advertisements may be repeated in the open slots or other messages (e.g., regarding the products available for sale from the machine) may be displayed during those time slots.

Table 1, below, provides one example schedule of messages played over a time period, where the schedule may be generated by the CPU in accordance with advertisement frequency parameters received over the network interface.

TABLE 1

| | | |
|---|---|---|
| 1st slot | 30 seconds | Starbucks |
| 2nd slot | 30 seconds | Charity (St. Jude Hospital) |
| 3rd slot | 30 seconds | State Farm Insurance |
| 4th slot | 30 seconds | J C Penny |
| 5th slot | 30 seconds | Vitamin Water |
| 6th slot | 30 seconds | Verizon |
| 7th slot | 30 seconds | Church of God |
| 8th slot | 30 seconds | Bank of America |
| 9th slot | 30 seconds | Delta Airlines |
| 10th slot | 30 seconds | University of Phoenix |
| 11th slot | 30 seconds | Discover card |
| 12th slot | 30 seconds | Avis Budget |
| 13th slot | 30 seconds | Naked Juice |
| 14th slot | 30 seconds | Charles Schwab |
| 15th slot | 30 seconds | Zales Jewelry |
| 16th slot | 30 seconds | L'Oreal |
| 17th slot | 30 seconds | Ikea Furniture |
| 18th slot | 30 seconds | Dish Network |
| 19th slot | 30 seconds | Mercedes Benz |
| 20th slot | 30 seconds | Adidas |

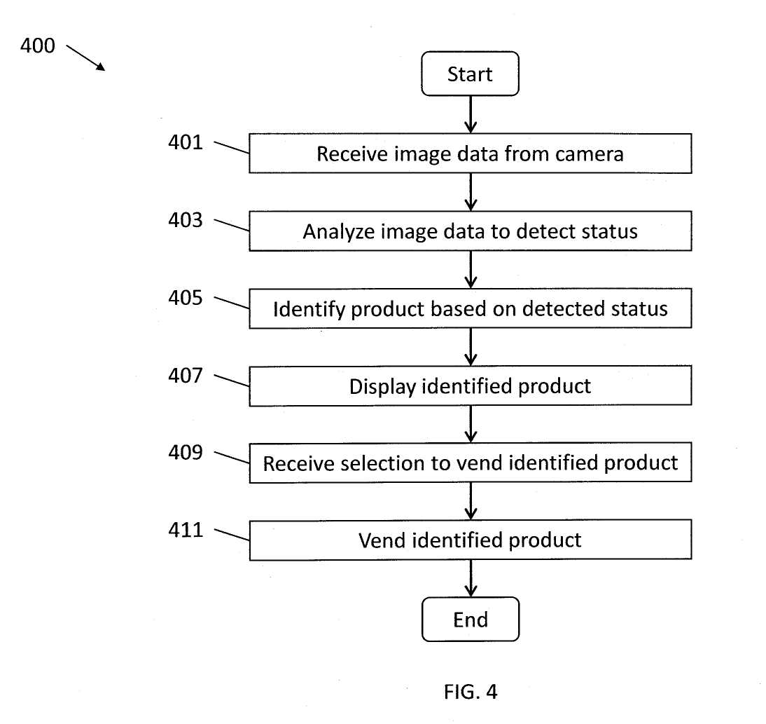

FIG. 4 is a flowchart illustrating a method for identifying and displaying recommended products in accordance with detected external information according to one embodiment of the present invention.

Referring to FIG. 4, in some embodiments of the present invention, the machine 100 includes one or more cameras 102 and 103 that capture status information such as “heat and/or aura signals” (e.g., infrared signals) from consumer/user. The detected status signals can be used to recommend particular products to the users based on the measured mood and/or aura signals.

For example, different detected heat level may be used to represent a mood or state and the computer 120 may use the detected heat level to recommend a product for the user. For example, a high heat level may be used to represent a more “upbeat” mood, and a drink that enhances energy (e.g., a sweeter or “brighter” drink) may be recommended to go with the “upbeat mood.” In some embodiments, when the computer 120 detects a heat level above a particular level the computer 120 automatically suggests cold drinks such as sodas to help the user cool off, whereas when the computer 120 detects a heat level below a particular level the computer 120 automatically suggests a warm drink such as coffee, tea, or hot chocolate, to help the consumer warm up.

In some embodiments of the present invention, the machine 100 automatically measures a consumer's aura via the onboard camera 102 or an aura sensor 103, which registers a spectrum of 12 colors. For example, red represents energy, strength, anger, sexually, passion, fear, and ego, and blue represents spiritual, loyal, creative, sensitive, kind, and moody . . . etc.

In some embodiments, the computer 120 is configured to automatically recommend a product matching the detected aura. For example, a more caffeinated product may be recommended to consumer who shows an aura that depicts low energy and exhaustion. The recommendation may be displayed on the display 104, and the user may directly select the recommendation without having to browse through menus of other available products.

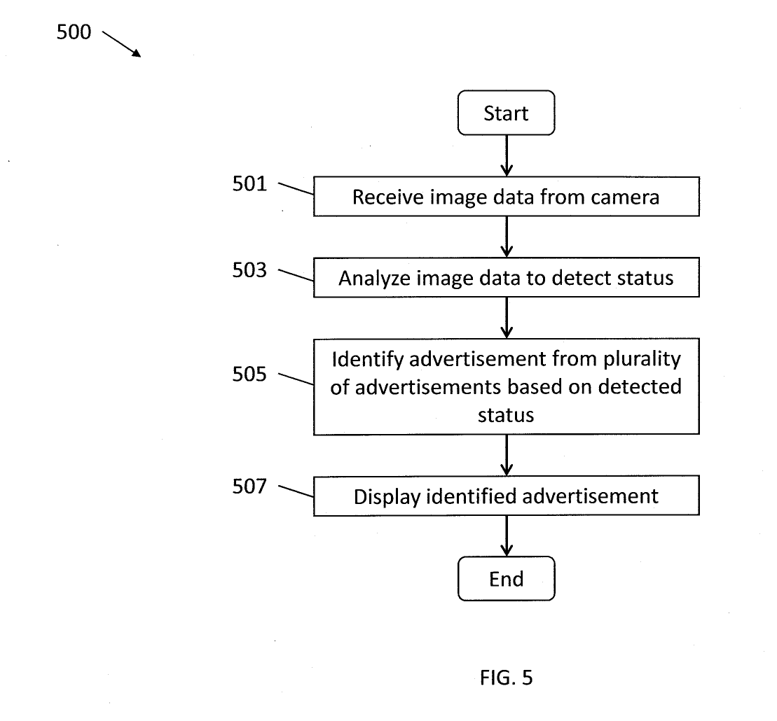

FIG. 5 is a flowchart illustrating a method for identifying and displaying an advertisement in accordance with detected external information according to one embodiment of the present invention.

Referring to FIG. 5, in some embodiments, the system may also automatically select the types of advertisements to be shown based on the detected status such as the mood and aura of people near the machine. For example, if the camera detects people in a more upbeat mood (e.g., detecting faster or bouncier movement) may be automatically shown more upbeat commercials (e.g., an advertisement for an action movie) on the display, while customers in a calmer mood may be automatically shown commercials that are calmer and quieter (e.g., for a calming cup of tea). The advertisements are automatically selected by the computer 120 based on their associated parameters. For example, some advertisements may be coded with particular keywords such as “passion” or “calm”. The detected mood is mapped to particular keywords and advertisements matching those keywords are selected for display.

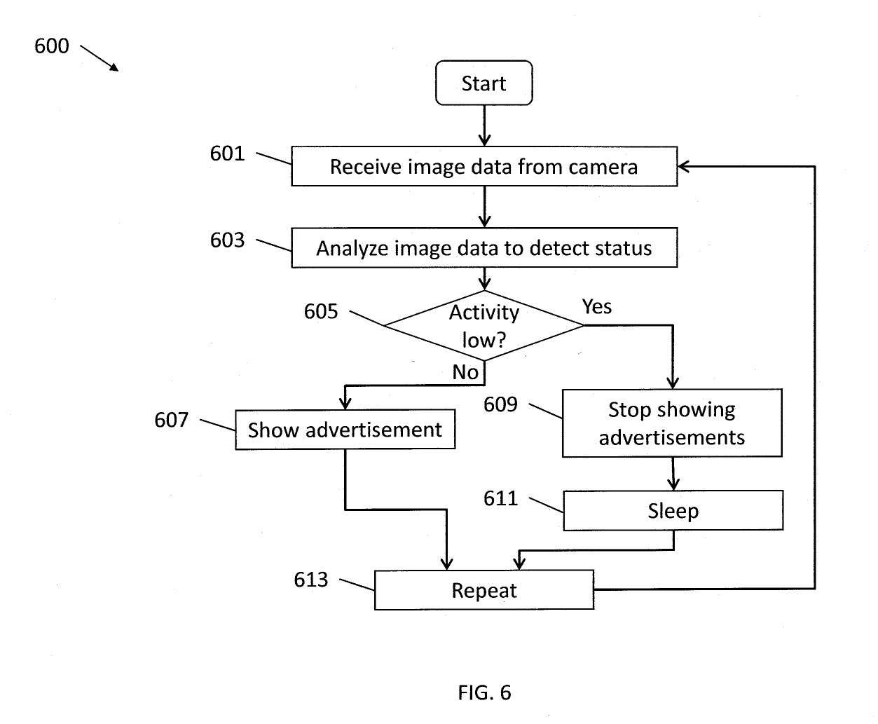

FIG. 6 is a flowchart illustrating a method for detecting activity and displaying an advertisement based on whether or not a low level of activity is detected according to one embodiment of the present invention.

Referring to FIG. 6, in one embodiment, the external camera 102 can be used to detect the amount of activity near the machine. For example, during low activity times in which no movement is detected by the camera, the computer system automatically sleeps (e.g., to stop showing advertisements) or automatically reduces the number of advertisements shown. On the other hand, when movement is detected, the system automatically begins to show advertisements again.

According to some embodiments of the present invention in which products are sold in containers that are filled at the time of purchase (e.g., a drink cup that is filled with the selected beverage only after the customer purchases it), the container is printed with a message or fortune message (or Bible verse, depending on the merchant and/or context), based on the customer's detected mood. For instance, a cheerful quote might be: “The most certain sign of wisdom is Cheerfulness.”—Michel de Montaigne and an energetic quote could be: “This world belongs to the energetic.”—Ralph Waldo Emerson.

In some embodiments of the present invention, advertising such as an advertiser's name or logo may be printed on the cups. Multiple different cups from different cup sponsors can be stocked in the machine and the computer 120 can control the dispenser controller 113 to select a cup having a logo matching the advertisement that is played at or near the time that the consumer made the purchase. For example, a customer purchasing coffee may be shown an auto insurance commercial on the display while their coffee is dispensed into a cup labeled with the auto insurance company's logo and contact information (e.g., website and/or phone number), while another customer may be shown an athletic shoe commercial while their drink is dispensed into a cup labeled with the athletic shoe company's logo and perhaps a special offer for viewers of the advertisement.

In some embodiments of the present invention, the machine 100 includes a GPS device to allow consumers to locate the nearest vending machine to their current location via a smart phone app. This feature may also utilize the global positioning system (GPS) technologies and mapping technologies to provide consumers with an easy way to identify nearby merchants.

In some embodiments of the present invention, each machine 100 is assigned with a unique SMS code that is displayed on a user-facing panel of the machine 100 (e.g., adjacent the display 104). The consumer could SMS that unique code to indicate his/her interest on more information/purchase direct on the product that they had just purchased.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof

What is claimed is:

1. A system for displaying advertising to consumers, the system comprising:
a display panel;
a product dispenser configured to dispense a plurality of products;
a computer system comprising a processor, memory, and a storage device, the computer system being configured to:
display a plurality of advertisements on the display panel, the advertisements being stored on the storage device;
receive a selection of a selected product from among the plurality of products; and
control the product dispenser to dispense the selected product,
wherein at least one of the plurality of advertisements is unrelated to the plurality of products.

2. The system of claim 1, wherein the system further comprises a camera, and
wherein the computer system is further configured to:
receive image data from the camera, the image data including an image of a person;
analyze the image data to detect a status of the person;
identify a recommended product from the plurality of products in accordance with the detected status; and
display the recommended product on the display.

3. The system of claim 2, wherein the status of the person comprises a mood of the person.

4. The system of claim 1, wherein the system further comprises a camera, and
wherein the computer system is further configured to:
receive image data from the camera;
analyze the image data to detect a status; and
display an advertisement from the plurality of advertisements in accordance with the detected status.

5. The system of claim 4, wherein the status comprises a mood of a person depicted in the image data.

6. The system of claim 4, wherein the computer system is further configured to:
detect whether activity is low based on image data;
show an advertisement when the detected activity is not low; and
stop showing advertisements and sleep when the detected activity is low.

7. The system of claim 1, wherein the system further comprises a network adapter and wherein the computer system is configured to receive the plurality of advertisements via the network adapter and to store the received plurality of advertisements on the storage device.
